(19) United States
(12) Patent Application Publication
(10) Pub. No.: US 2008/0089772 A1
(43) Pub. Date: Apr. 17, 2008

(54) SUCTION GRIPPER FOR HANDLING WORKPIECES

(75) Inventor: Peter MUELLER-HUMMEL, Kotz (DE)

Correspondence Address: GREENBLUM & BERNSTEIN, P.L.C., 1950 ROLAND CLARKE PLACE, RESTON, VA, 20191, US

(73) Assignee: EADS DEUTSCHLAND GmbH, Munich (DE)

(21) Appl. No.: 11/869,869

(22) Filed: Oct. 10, 2007

(30) Foreign Application Priority Data
Oct. 11, 2006 (DE) 10 2006 048 069.4

(51) Int. Cl. B65G 61/00

(52) U.S. Cl. 414/787; 414/800

(57) ABSTRACT

Apparatus and method for handling workpieces using a suction gripper having a suction plate including a plurality of suction openings connected to a vacuum source. The apparatus includes at least one vacuum source, a suction plate having a plurality of openings, at least one movable template, which defines an active area, positionable on the suction plate, and at least one pair of fans arranged to be contrarotating.

### CROSS-REFERENCE TO RELATED APPLICATIONS

The present application claims priority under 35 U.S.C. §119 of German Patent Application No. 10 2006 048 069.4, filed on Oct. 11, 2006, the disclosure of which is expressly incorporated by reference herein in its entirety.

### BACKGROUND OF THE INVENTION

1. Field of the Invention

The invention relates to a suction gripper for handling workpieces, in particular, to a suction gripper having a suction plate with a plurality of suction openings connected to a vacuum source.

2. Discussion of Background Information

Suction grippers of this type are used in aircraft construction, e.g., for handling flexible carbon fiber-reinforced plastic (CFRP) plies and are typically arranged on a robot arm. However, they can also be operated manually.

For example, a fabric gripper by Brötje Automation GmbH is known, having active suction face of the gripper adaptable to the contour of the workpiece to be transported. Suctioning is intended to occur only at the suction openings that bear against the workpiece in particular to prevent further objects (waste, offcuts) from being suctioned. The active suction face thus essentially corresponds to the contour of the workpiece itself. To this end, the suction openings on the suction plate can be individually controlled, i.e., each of the suction openings (or alternatively individual groups of suction openings) is equipped with a hose connection to the vacuum source and can be activated or deactivated individually via on-off valves. This complex structure makes this a very heavy and awkward device, which in particular cannot be used manually. The central vacuum source, e.g., a fan, is arranged in a stationary manner and is separate from the movable gripper. The power dissipation of the fan is high because of the great length of the suction lines required.

Suction grippers are known in the field of handling circuit boards. The perforated suction plate of a suction gripper can be optionally covered with different templates in order to establish areas of the suction plate with suction action (EP 0 267 874 A1, DE 196 46 186 A1, DE 43 35 735 A1).

In unpublished German application number DE 10 2005 023 487 A1, templates of this type are present in roll form and can be moved past the suction plate by rollers.

A suction gripper with suction box and a hood arranged thereon is known from DE 100 09 108 A1, which includes several vacuum blowers arranged inside a hood. An elastic suction pad is arranged on the suction plate, the openings of the suction pad correspond to the openings of the suction plate.

### SUMMARY OF THE INVENTION

According to the invention, a suction gripper includes a controllable active suction face. The suction gripper is very flexible in case of changing a template and is suitable for manual use.

In accordance with an aspect of the invention, a suction gripper for handling work pieces is provided. The suction gripper includes several templates and a device for positioning the templates on the suction plate to adjust the active area of the suction plate to suction by selecting a specific template. The templates can be in a strip form such that the individual templates are arranged sequentially, and the strip can be rolled up on rollers and can be moved past the suction plate by a roller drive. The vacuum sources include one or more pairs of fans, in which the fans of the pair are contrarotating and have parallel drive axles.

According to an embodiment of the invention, the active area of suction can be adjusted on the suction plate by several templates being present on the suction gripper. The templates can be applied to the suction plate of the suction gripper. A template may include permeable and impermeable areas, and a permeable area can correspond essentially to the workpiece contour. By selecting one of these templates, individual suction openings can be blocked out in a targeted manner, whereas other active suction openings all lie inside the workpiece contour.

In an embodiment of the invention, a light, manageable, suction gripper with controllable suction face is created, which can be used manually as well as non-manually. No complicated pipe connections, on-off valves, or complex electronic controls are required. Workpieces can be grasped and transported very precisely therewith, which is very important in particular with CFRP plies with very high susceptibility to distortion.

According to a further embodiment, the templates are made of a flexible, rollable film material, e.g., a plastic film or a fabric. The individual templates are lined up next to one another to form a strip that is rolled up on at least two separately driven rollers. The templates can be guided sequentially, in either direction, along the suction plate by using a reel drive (e.g., manually by way of a crank or electrically) in order to transport the desired template to the suction plate.

In another embodiment of the invention, vacuum sources, e.g., fans, are located in a housing having one limiting face which is formed by a suction plate. This produces a very structurally compact device. The fans are located directly behind the suction plate, i.e., in close proximity to the suction openings. Therefore, no hose or pipe connection is required between the suction plate and fan, however, some embodiments may include a hose or pipe connection to remove the outlet air. This short distance between the fan and active area of the suction device that hardly any pressure losses occur, such as are inevitable with longer lines. The power dissipation is thus very low. Because the fan is arranged proximally to the gripper head, the operator can control the function of the gripper very effectively and with low engineering effort. In particular the operator can adjust the power directly on the gripper, e.g., via a rotary handle, and switch the gripper on and off according to current requirements. Continuous operation of the fan, and the associated disadvantages such as noise pollution and/or inefficient use of energy, can be avoided by the operator's control actions.

The number of fans in any particular embodiment depends on the suction power required. According to one embodiment, exactly two contrarotating fans are used, and the drive axles of these fans are selected to be parallel to one another. A torque balance is achieved through this type of arrangement so that, consequently, no resulting torque acts on the suction gripper. The manageability of the suction gripper is thus greatly improved for the operator. The same effect may be achieved by using an even number of fans, if in each case the fans are contrarotating and have parallel drive axles.

The fans to be used can thereby include axial-flow fans as well as centrifugal fans (roller fans).

The described suction gripper is particularly suitable for handling dry, flexible fiber webs in the production of components of fiber-reinforced plastic. In aircraft construction these are often large-size components with dimensions in the range of several meters.

The invention is directed to a suction apparatus. The suction apparatus includes at least one vacuum source, a suction plate having a plurality of openings, and at least one movable template positionable on the suction plate. The at least one movable template defines an active area, and the at least one vacuum source includes at least one pair of fans, and at least one of the pairs of fans are arranged to be contrarotating.

According to an aspect of the invention, the at least one movable template can be composed of a flexible material. The flexible material can be a plastic film or a fabric.

In accordance with another aspect of the instant invention, the at least one moveable template can be arranged in a strip form.

According to still another feature of the invention, the at least one movable template may be advanced sequentially. Further, the at least one movable template can be advanced electronically or manually.

In accordance with another feature of the invention, the suction apparatus may include a roller device structured and arranged to move at least one movable template past at least two separately driven rollers.

Another feature of the invention includes the at least one vacuum source, which may be located proximally to the suction plate. The vacuum source may also be arranged in a housing having a face formed by the suction plate. The at least one vacuum source may be comprised of an even number of contrarotating fans.

According to yet another aspect of the invention, the at least one pair of fans can have parallel drive axles.

Further aspects of the invention may include an air distribution layer structured and arranged to provide a uniform flow distribution, the air distribution layer may be positionably adjacent to the suction plate. The air distribution layer may further be composed of at least an open-pore foam, a three-dimensional honeycomb or lattice structure, and made of at least one of a metal or plastic.

The invention is directed to a method for gripping workpieces. The method includes selecting a template, positioning the template on a suction plate, creating suction through the suction plate with at least one pair of fans arranged in contrarotation, and suctioning a workpiece corresponding in size and shape to openings in the template.

In accordance with an aspect of the present invention, the template may be composed from a flexible material such as a plastic film or a fabric.

According to another aspect of the invention, the template can be sequentially selected. The template can be arranged in strip form. The template can also be positioned electronically or manually. Furthermore, the template may include at least one permeable and at least one impermeable area, whereby a vacuum can suction the workpiece located proximate to the permeable area. The at least one permeable area may be shaped to a contour of the workpiece.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an isometric view of a suction gripper in accordance with the invention;

FIG. 2 shows a cross-sectional view of FIG. 1 in accordance with the invention;

FIG. 3 shows another embodiment of the suction gripper in accordance with the invention;

FIG. 4 shows an enlarged perspective of part of FIG. 3 in accordance with the invention;

FIG. 5 shows the suction plate of a suction gripper without a template in accordance with the invention;

FIG. 6 shows the suction plate of a suction gripper with one template added in accordance with the invention; and

FIG. 7 shows the suction plate of a suction gripper with a different template added in accordance with the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

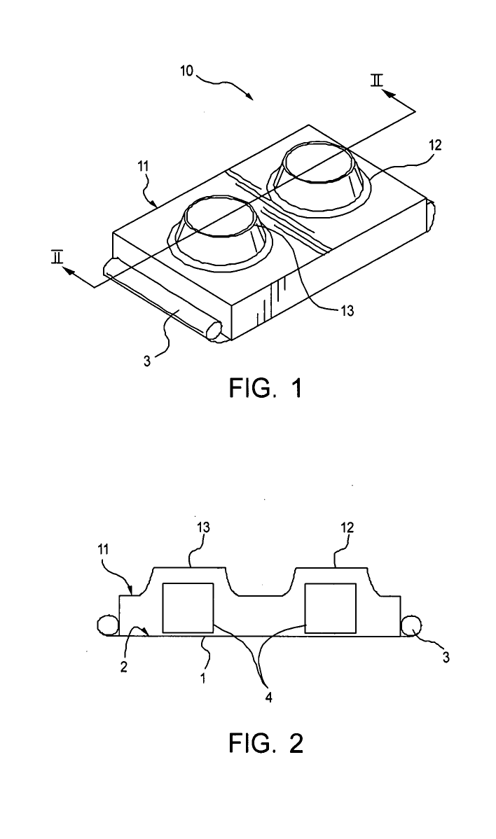

FIGS. 1 and 2 show an embodiment of a suction gripper 10 according to the invention. FIG. 1 illustrates a three-dimensional perspective of a suction gripper 10, and FIG. 2 illustrates a cross-sectional view of the suction gripper 10 presented along section line II-II depicted in FIG. 1. A suction gripper of this type can be arranged, for example, on the arm of a robot (not shown). The suction gripper 10 has a housing 11, the underside of which is formed by a suction plate 2 in which a multitude of suction openings are located, e.g., in a regular arrangement, to grip the workpiece to be transported.

The top of the housing 11 has two protuberances 12, 13, within which respectively a fan 4 is arranged to generate a vacuum (see FIG. 2). The fans 4 are thus located directly behind the suction plate 2 so that pressure losses are avoided. In one embodiment, the housing 11 may be connected at its protuberances 12, 13 to a hose for removing the outlet air. However, in alternative embodiments, it is also possible to emit the outlet air directly into the atmosphere. According to the invention, the fans can be arranged in one or more pairs, in which the fans of at least one pair are arranged to operate in contrarotation while the drive axles are parallel each other.

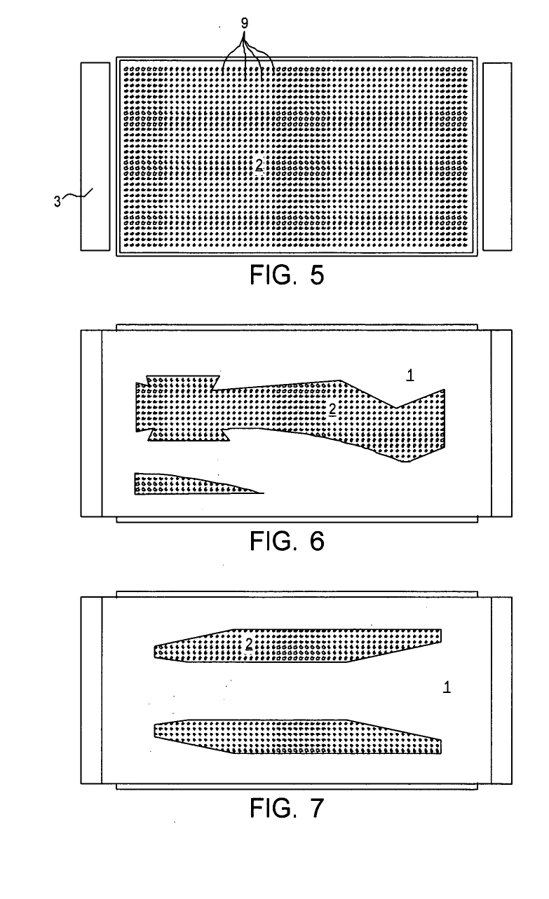

Two winding or unwinding devices, which are illustrated as rollers 3, are arranged at the side of the housing 11 of the suction gripper 10. While rollers are illustrated in this embodiment, it should be understood that alternative mechanisms for winding or unwinding may be used instead of rollers. The rollers 3 are configured to have one or more templates 1 (see FIG. 6) integrated to form a strip that may be wound onto the rollers 3. The templates 1 may be made of a flexible, rollable material, such as a fabric or a plastic film. The individual templates 1 may be sequentially or successively transported before the suction plate of the suction gripper 10 by rotating the rollers 3 in either direction in order to adjust a desired vacuum profile on the suction plate 2 (see FIG. 5). The rollers 3 can be driven, e.g., manually, electrically, or any other suitable manner.

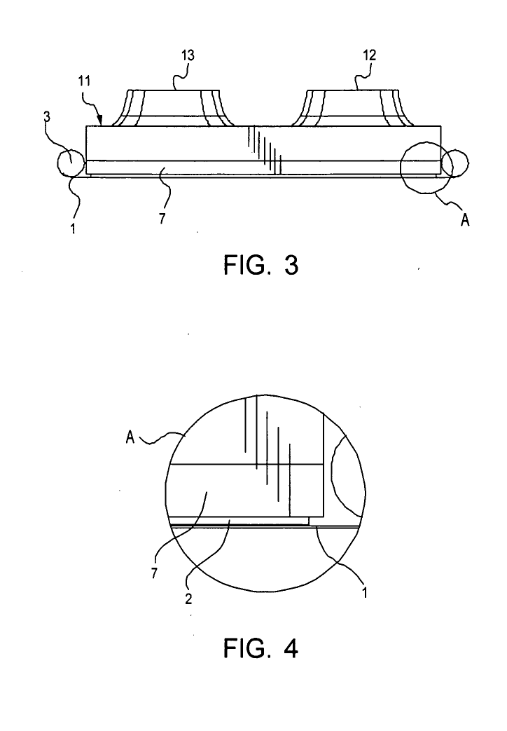

FIG. 3 shows another embodiment of the suction gripper shown in FIGS. 1 and 2. The detail in section A in FIG. 3 is shown on a larger scale in FIG. 4. In this embodiment, an air distribution layer 7 may be included behind the suction plate 2, i.e., relative to the flow direction. The air distribution layer 7 is arranged as a diffuser to homogenize the flow over the entire active area of the suction plate 2. An open-pore foam, for example, can be used here. Likewise possible are three-dimensional honeycomb or lattice structures, e.g., of metal. Other materials may be used for the air distribution layer 7 as well, as long as the materials permit a reliable, precise gripping of the workpiece without deformation.

FIG. 5 shows an image of a suction plate 2, i.e., without a template according to one embodiment of the invention. The suction plate 2 depicted in FIG. 5 can be a perforated sheet with a plurality of suction openings 9 arranged regularly. Alternatively, a lattice-shaped or honeycombed structure of metal or plastic can also be selected as a suction plate 2. The length of a suction plate 2 of this type can typically be, e.g., more than 2 m for use in aircraft construction.

FIGS. 6 and 7 show embodiments of a template 1 that may be arranged on the suction plate 2 in order to render possible suctioning with contour precision. The templates have perforated areas (here respectively two per template) that in each case correspond to the contour of a workpiece to be grasped. The suctioning thus occurs only in the area of the workpieces themselves, while the suction openings covered by the template 1 are inactive. This ensures that no additional material is suctioned in addition to the workpieces to be transported, which additional material would then first need to be removed again.

Of course, templates are also possible that have only one perforation (for transporting just one workpiece) or with any desired number of perforations for the transport of a corresponding number of workpieces.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A suction apparatus comprising:
at least one vacuum source;
a suction plate having a plurality of openings; and
at least one movable template positionable on the suction plate, wherein the at least one movable template defines an active area;
wherein the at least one vacuum source comprises at least one pair of fans, and at least one of the pairs of fans are arranged to be contrarotating.

2. The suction apparatus of claim 1, wherein the at least one movable template is composed of a flexible material.

3. The suction apparatus of claim 2, wherein the flexible material is a plastic film or a fabric.

4. The suction apparatus of claim 1, wherein the at least one moveable template is arranged in a strip form.

5. The suction apparatus of claim 1, wherein the at least one movable template is advanced sequentially.

6. The suction apparatus of claim 5, wherein the at least one movable template is advanced electronically or manually.

7. The suction apparatus of claim 1, further comprising a roller device structured and arranged to move at least one movable template past at least two separately driven rollers.

8. The suction apparatus of claim 1, wherein the at least one vacuum source is located proximally to the suction plate.

9. The suction apparatus of claim 1, wherein the at least one vacuum source is comprised of an even number of contrarotating fans.

10. The suction apparatus of claim 1, wherein the at least one pair of fans has parallel drive axles.

11. The suction apparatus of claim 1, further comprising an air distribution layer structured and arranged to provide a uniform flow distribution, the air distribution layer is positionably adjacent to the suction plate.

12. The suction apparatus of claim 11, wherein the air distribution layer is composed of at least: an open-pore foam, a three-dimensional honeycomb or lattice structure, and made of at least one of a metal or plastic.

13. The suction apparatus of claim 1, wherein the at least one vacuum source is arranged in a housing having a face formed by the suction plate.

14. A method for gripping workpieces, comprising:
selecting a template;
positioning the template on a suction plate;
creating suction through the suction plate with at least one pair of fans arranged in contrarotation; and
suctioning a workpiece corresponding in size and shape to openings in the template.

15. The method for gripping workpieces of claim 14, wherein the template is composed from a flexible material such as a plastic film or a fabric.

16. The method for gripping workpieces of claim 14, wherein the template is sequentially selected.

17. The method for gripping workpieces of claim 14, wherein the template is arranged in strip form.

18. The method for gripping workpieces of claim 14, wherein the template is positioned electronically or manually.

19. The method for gripping workpieces of claim 14, wherein the template includes at least one permeable and at least one impermeable area, whereby a vacuum can suction the workpiece located proximate to the permeable area.

20. The method for gripping workpieces of claim 19, wherein the at least one permeable area is shaped to a contour of the workpiece.
